(19) United States
(12) Patent Application Publication
(10) Pub. No.: US 2026/0059487 A1
(43) Pub. Date: Feb. 26, 2026

(54) POSITION RELIABILITY INFORMATION FOR DEVICE POSITION

(71) Applicant: Lenovo (Singapore) Pte. Limited, Singapore (SG)

(72) Inventors: Alexander Golitschek Edler von Elbwart, Darmstadt (DE); Robin Rajan Thomas, Bad Nauheim (DE); Karthikeyan Ganesan, Kronberg Im Taunus (DE); Abir Ben Hadj Fredj, Wiesbaden (DE); Khaled Nafez Rauf Ardah, Ilmenau (DE)

(73) Assignee: Lenovo (Singapore) Pte. Limited, Singapore (SG)

(21) Appl. No.: 19/102,567

(22) PCT Filed: Aug. 9, 2023
(86) PCT No.: PCT/IB2023/058063

§ 371 Date: Feb. 10, 2025

Related U.S. Application Data
(60) Provisional application No. 63/396,828, filed on Aug. 10, 2022.
(60) Provisional application No. 63/396,839, filed on Aug. 10, 2022.

(51) Int. Cl. H04W 64/00; H04L 5/00

(52) U.S. Cl. CPC H04W 64/003; H04L 5/0048

(57) ABSTRACT

Various aspects of the present disclosure relate to methods, apparatuses, and systems that position reliability information for device position. For instance, position reliability information indicates an estimated trust status (e.g., reliability) of position information that a receiving device can utilize to determine how and/or whether to use to position information. In at least some implementations, a device (e.g., a user equipment (UE) and/or a network entity such as a gNB) can utilize position information that is indicated a reliable (e.g., trusted), whereas the device can disregard position information that is indicated as unreliable, e.g., untrusted.

### RELATED APPLICATION

This application claims priority to U.S. Patent Application Ser. No. 63/396,828 filed 10 Aug. 2022 entitled “POSITION RELIABILITY INFORMATION FOR DEVICE POSITION,” and to U.S. Patent Application Ser. No. 63/396,839 filed 10 Aug. 2022 entitled “PRIORITY FOR POSITIONING INFORMATION,” the disclosures of which are incorporated by reference herein in their entirety.

### TECHNICAL FIELD

The present disclosure relates to wireless communications, and more specifically to position determination in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for device positioning, such as for UE positioning. However, some techniques do not support efficient determination of which position information and which position information sources to use to determine UE positioning.

### SUMMARY

The present disclosure relates to methods, apparatuses, and systems that support position reliability information for device position. For instance, position reliability information indicates an estimated trust status (e.g., reliability) of position information that a receiving device can utilize to determine how and/or whether to use to position information. In at least some implementations, a device (e.g., a UE and/or a network entity such as a gNB) can utilize position information that is indicated a reliable (e.g., trusted), whereas the device can disregard position information that is indicated as unreliable, e.g., untrusted.

By utilizing the described techniques, speed, accuracy, and reliability of position information and position determination in wireless systems is increased.

Some implementations of the methods and apparatuses described herein may further include generating, at an apparatus, position reliability information, where the position reliability information includes an estimated indication of a trust status of the position for a device; and transmitting the position reliability information.

In some implementations of the methods and apparatuses described herein, the position reliability information is one or more of determined by or includes at least one of a velocity, an accuracy, a velocity class, or an accuracy class; the apparatus includes the device for which the position reliability information is generated; further including transmitting the position reliability information and a positioning reference signal; the position reliability information includes a message from a location management function (LMF) entity; the apparatus includes a device other than a device for which the position reliability information is generated; the position reliability information includes an indication of a mobility of the device; the position reliability information includes an indication of the position reliability for a plurality of spatial dimensions; the position reliability information includes an indication of a time to live for the position reliability information; the position reliability information includes an indication of a reliability value of the position reliability information relative to a defined threshold reliability.

Some implementations of the method and apparatuses described herein may further include receiving, at an apparatus, position reliability information, where the position reliability information includes an estimated indication of a trust status of the position for a first device; and estimating a position of a second device based at least in part on the position reliability information for the first device.

In some implementations of the methods and apparatuses described herein, the position reliability information includes one or more of a velocity, an accuracy, a velocity class, or an accuracy class; the apparatus includes the second device for which the position is estimated; further including transmitting the position reliability information and a positioning reference signal; the position reliability information includes a message from a location management function (LMF) entity; the apparatus includes a device other than a device for which the position reliability information is generated; the position reliability information includes an indication of a mobility of the device; the position reliability information includes an indication of the position reliability for a plurality of spatial dimensions; the position reliability information includes an indication of a time to live for the position reliability information; the position reliability information includes an indication of a reliability value of the position reliability information relative to a defined threshold reliability.

### BRIEF DESCRIPTION OF THE DRAWINGS

FIG. 1 illustrates an example of a wireless communications system that supports position reliability information for device position in accordance with aspects of the present disclosure.

FIG. 2 illustrates a system which can utilize different types of connectivity for determining device position.

FIG. 3 illustrates an example system that supports positioning.

FIG. 4 illustrates a system that can transmit PRS.

FIG. 5 illustrates an overview of absolute and relative positioning scenarios.

FIGS. 6 and 7 illustrate examples of block diagrams of devices that support position reliability information for device position in accordance with aspects of the present disclosure.

FIGS. 8 through 12 illustrate flowcharts of methods that support position reliability information for device position in accordance with aspects of the present disclosure.

### DETAILED DESCRIPTION

In some wireless communications systems, ways are provided for device positioning, such as for UE positioning. Further, for PRS transmission such as in the context of sidelink transmissions, a UE-based positioning estimate may rely on PRS transmitted by a plurality of downlink and/or sidelink transmissions. Sidelink PRS may be transmitted by a mobile device, but fixed sidelink transmitters are also utilized such as roadside units (RSU) and/or UEs that are temporarily stationary. A UE estimating its position by measuring signals from other UEs may rely on an accurate knowledge of the location of the PRS transmitter. To have a sufficiently reliable estimate, the PRS of multiple PRS transmitters can be detected and evaluated. However, some wireless communications systems fail to indicate a reliability on the knowledge of a PRS transmitter position, which may result in reduced accuracy for position determination.

Accordingly, the present disclosure relates to methods, apparatuses, and systems that support position reliability information for device position. For instance, position reliability information indicates an estimated trust status (e.g., reliability) of position information that a receiving device can utilize to determine how and/or whether to use to position information. In at least some implementations, a device (e.g., a UE and/or a network entity such as a gNB) can utilize position information that is indicated a reliable (e.g., trusted), whereas the device can disregard position information that is indicated as unreliable, e.g., untrusted.

By utilizing the described techniques, speed, accuracy, and reliability of position information and position determination in wireless systems is increased. The described techniques can also reduce signaling overhead and usage of device resources such as processing and wireless resources.

Aspects of the present disclosure are described in the context of a wireless communications system. Aspects of the present disclosure are further illustrated and described with reference to device diagrams and flowcharts.

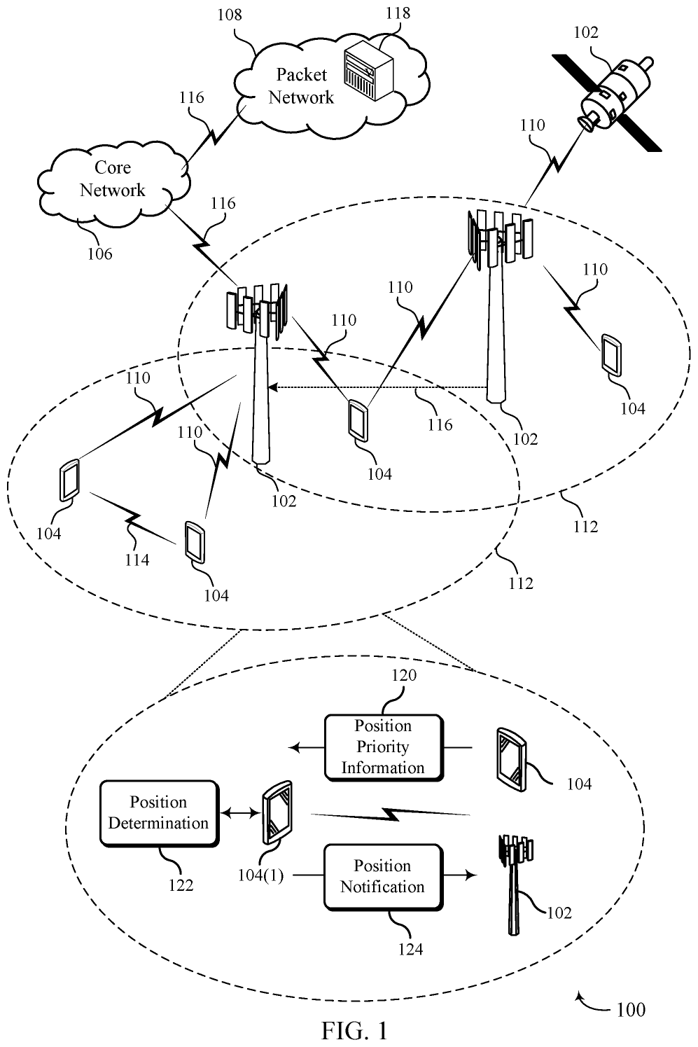

FIG. 1 illustrates an example of a wireless communications system 100 that supports position reliability information for device position in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for position reliability information for device position, a UE 104(1) can receive position reliability information 120 from a positioning reference node such as a different UE 104, a network entity 102, and so forth. The position reliability information 120, for instance, can accompany PRS from a positioning reference node. Alternatively the position reliability information 120 can include position reliability information without PRS. Accordingly, based at least in part on the position reliability information 120 the UE 104(1) performs position determination 122. For instance, based on the position reliability information 120, the UE 104(1) processes PRS to determine whether to use the PRS and/or which PRS to use to determine a position of the UE 104(1). Based on the position determination, the UE 104(1) generates a position notification 124 that indicates an estimated position of the UE 104(1). In at least one implementation the position notification 124 also indicates a trust status of the position information, e.g., how confident the UE 104(1) is that its position determination is accurate. Accordingly, the UE 104(1) can transmit the position notification 124, such as to a network entity 102 and/or a different UE 104.

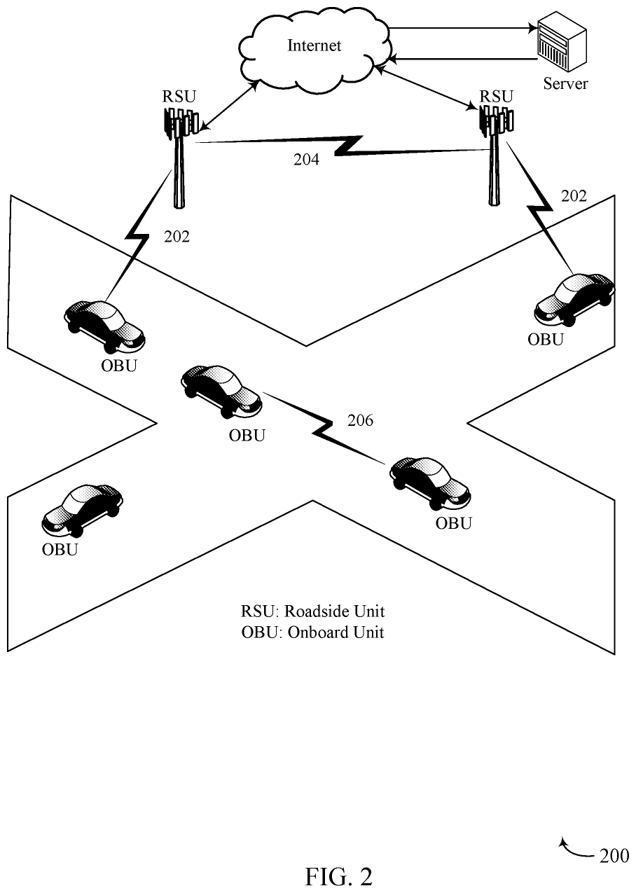

FIG. 2 illustrates a system 200 which can utilize different types of connectivity for determining device position. The system 200 includes different infrastructure components including roadside units (RSU) and a server which are interconnected via a network such as the Internet. Further, the system 200 includes vehicles with onboard units (OBU) which are capable of wireless communication. The various components of the system 200 can intercommunicate via wireless connectivity including infrastructure to vehicle communication 202, infrastructure to infrastructure communication 204, and vehicle to vehicle communication 206. The different communications, for instance, can be utilized for determining positions of the vehicles in the system 200.

In some wireless communications systems, NR positioning based on NR Uu signals and standalone (SA) architecture (e.g., beam-based transmissions) are specified such as specified in Rel-16. The targeted use cases include commercial and regulatory (emergency services) scenarios such as as in Rel-15. The performance requirements include the following:

| Positioning Error | Indoor | Outdoor |
|---|---|---|
| Horizontal | <3 m for 80% of UEs | <10 m for 80% of UEs |
| Positioning | | |
| Vertical Positioning | <3 m for 80% of UEs | <3 m for 80% of UEs |

Current 3GPP Rel-17 Positioning has recently defined the positioning performance requirements for Commercial and IIoT use cases as follows:

| Positioning Error | Commercial | IIoT |
|---|---|---|
| Horizontal Positioning | (<1 m) for 90% of | (<0.2 m) for 90% of |
| | UEs | UEs; |
| Vertical Positioning | (<3 m) for 90% of | (<1 m) for 90% of UEs |
| | UEs | |
| Physical layer latency | (<10 ms) | (<10 ms) |
| for position estimation | | |
| of UE | | |
| End-to-End Latency | (<100 ms) | (<100 ms, in the order |
| for position estimation | | of 10 ms is desired) |
| of UE | | |

5G NR provides a few enhanced parameters for positioning accuracy estimation than previous mobile generations, particularly with regards to time- and angle-based positioning methods. For instance:
The delay error variance decreases in the order of the square of the bandwidth as the bandwidth increases. However, the angle variance is completely independent of the bandwidth. NR provides significant bandwidth improvement over LTE; while LTE provides a maximum of 20 MHz, NR provides up to 100 MHz in frequency range 1 and 400 MHz in frequency range 2.
Received power is inversely proportional to all estimate variances. In NR, received power can be increased by beamforming. This is especially more important for numerologies with higher subcarrier spacings.
NR provides five different choices for subcarrier spacing: 15 kHz, 30 kHz, 60 kHz, 120 kHz and 240 kHz. The subcarrier-spacing is a bit peculiar since it gives a linear increase to the angle variances, while at the same time giving only a linear decrease to the delay variance. This effect is derived from the noise variance increasing linearly with the subcarrier spacing. A natural way to counter this is to increase the receiver power.
Different antenna patterns, in terms of spacings and number of polarizations in relation to rows and columns in antenna array etc. do not affect the delay variance, but rather only the total number of antenna elements in the array matter. For the angle estimates, the variance is proportional to the inverse square of the antenna spacing. Furthermore, the number of rows and columns respectively of the antenna array gives a cubic decrease in the angle estimate variances. Typically, NR equipment carries a larger number of antennas.

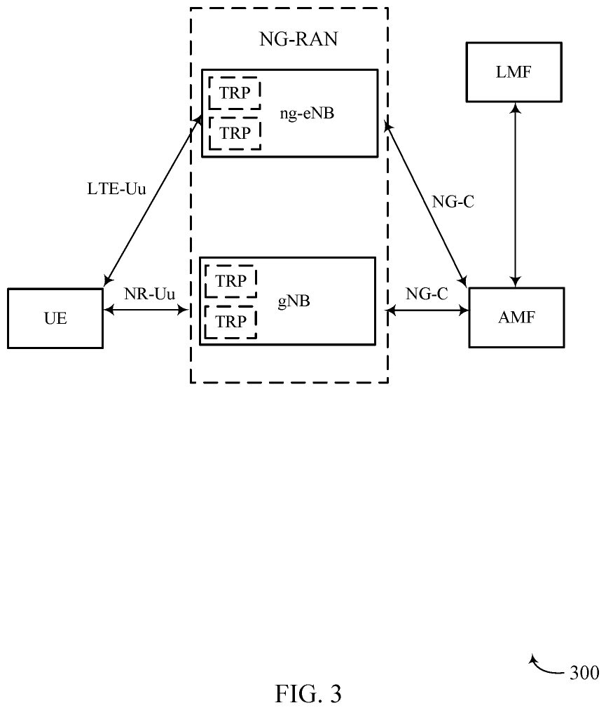

FIG. 3 illustrates an example system 300 that supports positioning. In the system 300 the location management function (LMF) is central in the 5G positioning architecture. The LMF receives measurements and assistance information from the next generation radio access network (NG-RAN) and the mobile device (UE) via the access and mobility management function (AMF) over the NLs interface to compute the position of the UE. Due to the new next generation interface between the NG-RAN and the core network, a new NR positioning protocol A (NRPPa) protocol was introduced to carry the positioning information between NG-RAN and LMF over the next generation control plane interface (NG-C). These additions in the 5G architecture provide the framework for positioning in 5G. The LMF configures the UE using the LTE positioning protocol (LPP) via AMF. The NG RAN configures the UE using RRC protocol over LTE-Uu and NR-Uu.

To enable more accurate positioning measurements than LTE, new reference signals were added to the NR specifications. These signals are the PRS in the downlink and the sounding reference signal (SRS) for positioning in the uplink. The downlink PRS is the main reference signal supporting downlink-based positioning methods. Although other signals can be used, PRS is specifically designed to deliver the highest possible levels of accuracy, coverage, and interference avoidance and suppression.

To design an efficient PRS, special care was taken to give the signal a large delay spread range, since it must be received from potentially distant neighboring base stations for position estimation. This is achieved by covering the whole NR bandwidth and transmitting PRS over multiple symbols that can be aggregated to accumulate power. The density of subcarrier occupied in a given PRS symbol is referred to as the comb size. There are several configurable comb-based PRS patterns for comb-2,4,6 and 12 suitable for different scenarios serving different use cases. The pattern shown in the figure corresponds to comb-6 with 3 base stations multiplexed over one slot duration. For comb-N PRS, N symbols can be combined to cover all the subcarriers in the frequency domain.

Each base station can then transmit in different sets of subcarriers to avoid interference. Since several base stations can transmit at the same time without interfering with each other, this solution is also latency efficient. Moreover, it is possible to mute the PRS signal from one or more base stations at a given time according to a muting pattern, further lowering the potential interference. For use cases with higher transmission loss (for example, in macro cell deployments) the PRS can be also configured to be repeated to improve hearability.

Examples of supported positioning techniques in Rel-16 are listed in Table 1:

TABLE 1
Supported Rel-16 UE positioning methods

| | | UE- | NG- | |
|---|---|---|---|---|
| | | assisted, | RAN | |
| | UE- | LMF- | node | |
| Method | based | based | assisted | SUPL |
| A-GNSS | Yes | Yes | No | Yes (UE-based and |
| | | | | UE-assisted) |
| OTDOA ^{Note1, Note 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{Note1}
This includes TBS positioning based on PRS signals.
^{Note 2}
In this version of the specification only OTDOA based on LTE signals is supported.
^{Note 4}
This includes Cell-ID for NR method.
^{Note 5}
In this version of the specification only for TBS positioning based on MBS signals.

Separate positioning techniques as indicated in Table 1 can be currently configured and performed based on the requirements of a location management function (LMF) and UE capabilities. The transmission of Uu (uplink and downlink) PRS enable the UE to perform UE positioning-related measurements to enable the computation of a UE's absolute location estimate and are configured per Transmission Reception Point (TRP), where a TRP may include a set of one or more beams. A conceptual overview is illustrated in FIG. 1.

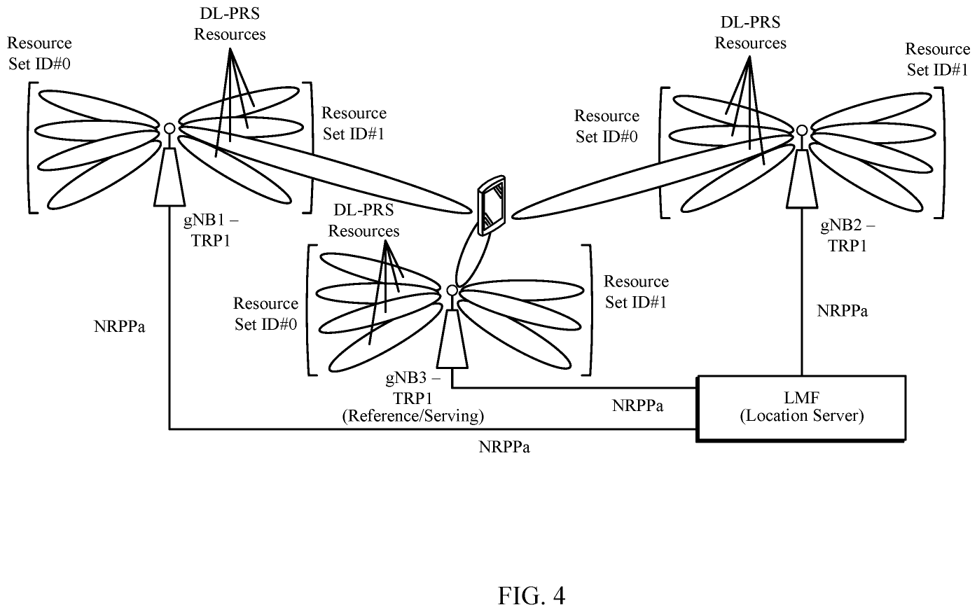

FIG. 4 illustrates a system 400 that can transmit PRS. The system 400, for instance, illustrates that according to Rel-16, the PRS can be transmitted by different base stations (serving and neighboring) using narrow beams over FR1 and FR2, which is relatively different when compared to LTE where the PRS was transmitted across the whole cell. The PRS can be locally associated with a PRS Resource identifier (ID) and Resource Set ID for a base station (TRP). Similarly, UE positioning measurements such as Reference Signal Time Difference (RSTD) and PRS reference signal received power (RSRP) measurements are made between beams (e.g., between a different pair of downlink (DL) PRS resources or DL PRS resource sets) as opposed to different cells as was the case in LTE. In addition, there are additional uplink (UL) positioning methods for the network to exploit in order to compute the target UE's location. RAT-dependent positioning techniques involve the 3GPP RAT and core network entities to perform the position estimation of the UE, which are differentiated from RAT-independent positioning techniques which rely on global navigation satellite systems (GNSS), inertial measurement unit (IMU) sensor, WLAN and Bluetooth technologies for performing target device (UE) positioning.

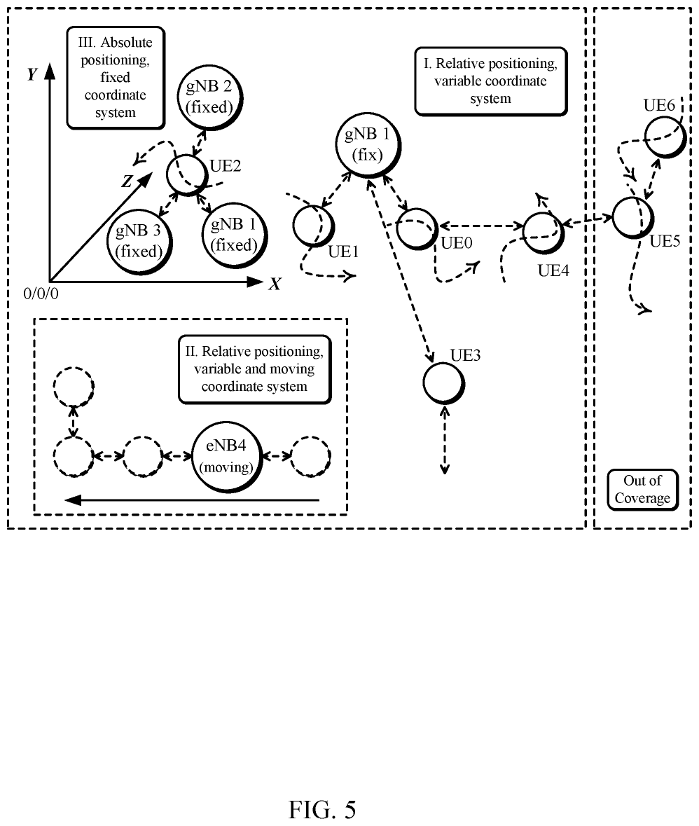

FIG. 5 illustrates an overview of absolute and relative positioning scenarios, such as defined in a system architecture using three different coordinate systems.
Absolute Positioning, fixed coordinate systems
Relative Positioning, variable and moving coordinate system
Relative Positioning, variable coordinate system

The following RAT-dependent positioning techniques are supported in Rel-16 and Rel-17:

### DL-TDoA

The DL-time difference of arrival (TDOA) positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

### DL-AoD

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

### Multi-RTT

The multi-round trip time (RTT) positioning method makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE.

The UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the RTT at the positioning server which are used to estimate the location of the UE (See FIG. 4). Multi-RTT is only supported for UE-assisted/NG-RAN assisted positioning techniques as noted in Table 1.

### E-CID/NR E-CID

In Enhanced Cell ID (CID) positioning method, the position of a UE is estimated with the knowledge of its serving ng-eNB, gNB and cell and is based on LTE signals. The information about the serving ng-eNB, gNB and cell may be obtained by paging, registration, or other methods. NR Enhanced Cell ID (NR E CID) positioning refers to techniques which use additional UE measurements and/or NR radio resource and other measurements to improve the UE location estimate using NR signals.

Although NR E-CID positioning may utilize some of the same measurements as the measurement control system in the RRC protocol, the UE generally is not expected to make additional measurements for the sole purpose of positioning; i.e., the positioning procedures do not supply a measurement configuration or measurement control message, and the UE reports the measurements that it has available rather than being required to take additional measurement actions.

### UL-TDoA

The UL TDOA positioning method makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

### UL-AoA

The UL AoA positioning method makes use of the measured azimuth and the zenith of arrival at multiple RPs of uplink signals transmitted from UE. The RPs measure A-AoA and Z-AoA of the received signals using assistance data received from the positioning server, and the resulting measurements are used along with other configuration information to estimate the location of the UE.

### RAT-Independent Positioning Techniques:

### Network-Assisted GNSS Methods

These methods make use of UEs that are equipped with radio receivers capable of receiving GNSS signals. In 3GPP specifications the term GNSS encompasses both global and regional/augmentation navigation satellite systems.

Examples of global navigation satellite systems include global positioning system (GPS), Modernized GPS, Galileo, GLONASS, and BeiDou Navigation Satellite System (BDS). Regional navigation satellite systems include Quasi Zenith Satellite System (QZSS) while the many augmentation systems, are classified under the generic term of Space Based Augmentation Systems (SBAS) and provide regional augmentation services. In this concept, different GNSSs (e.g., GPS, Galileo, etc.) can be used separately or in combination to determine the location of a UE.

### Barometric Pressure Sensor Positioning

The barometric pressure sensor method makes use of barometric sensors to determine the vertical component of the position of the UE. The UE measures barometric pressure, optionally aided by assistance data, to calculate the vertical component of its location or to send measurements to the positioning server for position calculation. This method should be combined with other positioning methods to determine the 3D position of the UE.

### WLAN Positioning

The wireless local access network (WLAN) positioning method makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated.

Alternatively, the UE makes use of WLAN measurements and optionally WLAN AP assistance data provided by the positioning server, to determine its location.

### Bluetooth Positioning

The Bluetooth positioning method makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g., WLAN) to improve positioning accuracy of the UE.

### TBS Positioning

A Terrestrial Beacon System (TBS) consists of a network of ground-based transmitters, broadcasting signals only for positioning purposes. The current type of TBS positioning signals are the MBS (Metropolitan Beacon System) signals and PRS. The UE measures received TBS signals, optionally aided by assistance data, to calculate its location or to send measurements to the positioning server for position calculation.

### Motion Sensor Positioning

The motion sensor method makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method should be used with other positioning methods for hybrid positioning.

To improve on challenges presented in device positioning in some wireless communications systems, the present disclosure details solutions for determining and identifying reliability of position information, e.g., PRS. Further, priority information for determining priority of position information transmitters and position information data itself.

The following terms may be used within this disclosure and the following represents some example non-limiting explanations for these terms:
Target-UE may be referred to as a UE of interest whose position (absolute or relative) is to be obtained by a network or by the UE itself.
Sidelink positioning: Positioning UE using reference signals transmitted over sidelink (SL) (e.g., PC5 interface) to obtain absolute position, relative position, and/or ranging information.
Ranging: determination of a distance and/or a direction between a UE and another entity, e.g., an anchor UE.
Anchor UE: UE supporting positioning of a target UE, e.g., by transmitting and/or receiving reference signals for positioning, providing positioning-related information, etc., such as over a sidelink interface.
SL positioning node may refer to a network entity and/or device (e.g., a UE) participating in a SL positioning session, and may be implemented as an LMF (location server), gNB, UE, RSU, anchor UE, initiator and/or responder UE, etc.
SL PRS (pre-)configuration: (pre-)configured parameters of SL PRS such as time-frequency resources (other parameters are not precluded) including its bandwidth and periodicity.

According to implementations, position reliability information is generated and conveyed to a positioning reference node (PRN) (such as an RSU) about the reliability of the PRN location accuracy or the PRN mobility. This information, for example, may be used by other nodes that determine their own position relative to an anchor node (e.g., PRN) or using knowledge about the anchor node mobility.

A PRN can refer to a node that is capable of transmitting PRS and/or other signals intended for measuring a relative or absolute position. This does not necessarily imply that such a node is actually used as a reference in the system, e.g. if the node is highly mobile with respect to other nodes, it may not be used as a positioning reference by such other nodes.

In at least one implementation a node in a communication system conveys position reliability information, e.g., information about the mobility and/or positioning reliability of positioning information such as PRS. A node conveying the position reliability information may be for example:
A PRN transmitting position reliability information pertaining to itself.
   For example, an anchor node may transmit position reliability information along with PRS or independently of PRS, such as in a unicast message, groupcast message, and/or broadcast message receivable by other nodes in the communication system.
      Other nodes may be other UEs in a communication range of the anchor node and/or a network node such as a gNB or LMF entity.
A network node (such as gNB, LMF, and/or other network functional entity) may transmit the position reliability information pertaining to a PRN.
   For example, an LMF may indicate one or more identities of PRNs that may be considered to be stationary and/or whose position information can be expected to have a high reliability. Alternatively or additionally the LMF may indicate one or more identities of PRNs that may be considered to be mobile and/or whose position information can be expected to have a low reliability.

In at least one implementation position reliability information for a PRN can be one or more of:
Whether the PRN is stationary or mobile
   E.g. a gNB, RSU or CPE can be considered stationary
Whether or not PRS exceeds a preconfigured velocity
A mobility class indicator as indicated in Table 2 and Table 3 below, e.g.:

TABLE 2
Binary indicator

| Class | Velocity |
|---|---|
| 1 | Stationary, <=0.01 m/s (or stationary anchor) |
| 2 | Non-Stationary, >0.01 m/s (or non stationary |
| | anchor, mobile anchor) |

TABLE 3
Non-binary indicator

| Class | Velocity |
|---|---|
| 1 | Stationary, <=0.01 m/s |
| 2 | Pedestrian, <=0.83 m/s |
| 3 | Moderate Mobility, <=8.3 m/s |
| 4 | High Mobility, >8.3 m/s |

In at least one implementation if multiple velocity indicators apply, the most stringent applicable velocity class (e.g., smallest velocity) can be utilized.

In at least one implementation, configurability of corresponding classes/velocity values or ranges is an optional element. Further, in at least some implementations the indicated velocity or the velocity upon which an indicated reliability class is determined is an “absolute” velocity, e.g., the velocity with respect to a stationary environment such as a global coordinate system, a fixed installation such as gNB, RSU, etc. According to an alternative or additional implementation, the indicated velocity or the velocity upon which an indicated reliability class is determined is a velocity relative to the recipient of the information, such as another UE like a target UE.

Position reliability information for a PRN can also include one or more of:
Standard deviation of the estimated position to a configurable value
   For example, a high reliability may be indicated if the variance is below 0.5 metres, a low reliability may be indicated if the variance is equal to or above 0.5 metres
      The threshold value may be configurable according to an accuracy parameter (e.g., accuracy requirement) of a positioning use case
      The position reliability information may reflect multiple accuracies, e.g., the information can indicate one or more accuracy thresholds that can be met or cannot be met.
         For example, the reliability may indicate which out of a plurality of accuracies can be fulfilled, such that other nodes may determine based on their positioning use case (e.g., accuracy parameter) whether a PRN is a useful PRN for obtaining positioning information.

Tables 4 and 5 illustrate examples for different accuracy indicators that can be included in position reliability information.

TABLE 4
Binary indicator

| Class | Accuracy |
|---|---|
| 1 | High accuracy, e.g. accuracy <0.5 m |
| 2 | Low accuracy, e.g. >=0.5 m |

TABLE 5
Non-binary indicator

| Class | Accuracy |
|---|---|
| 1 | Accuracy class 1, e.g. accuracy <0.5 m |
| 2 | Accuracy class 2, e.g. accuracy <1.5 m |
| 3 | Accuracy class 2, e.g. accuracy <2.5 m |
| 4 | Accuracy class 2, e.g. accuracy >=2.5 m |

Regarding tables 4 and 5, if multiple classes apply, position reliability information can indicate a most stringent applicable accuracy/reliability class, e.g., a highest fulfilled accuracy. Further, in at least some implementations, configurability of corresponding classes/accuracy values or ranges is an optional element.

According to one or more implementations, position reliability information can further be enhanced as follows:
The mobility characteristic (e.g., stationary/mobile) may be further described per dimension, e.g., a drone may be temporarily stationary in height but not in latitude or longitude. For instance, a vertical velocity may be small but a horizontal velocity may be comparably large.
Additional position reliability information can include speed and/or direction of movement a PRS transmitter, for instance absolute or with respect to a PRS measuring device, e.g., towards or away from a target UE.

According to one or more implementations, position reliability information can be provided to:
one or more PRS receivers, e.g., by means of an indication along with DL/SL control information.
An LMF, e.g., together with a location report.
   An LMF may also give mobility information of potential PRS transmitters to a target UE.

According to one or more implementations, position reliability information includes a time-to-live indication, e.g., for how long (and/or until when) the corresponding position reliability information can be considered to be valid. Alternatively or additionally the position reliability information includes an expiry indication, e.g., after how much time (and/or after what time value) corresponding position reliability information is to be considered to be invalid.

Implementations described herein also enable positioning prioritization (e.g., prioritizing of positioning information transmitters and/or positioning information) according to different criteria. For instance, positioning prioritization can be applied to positioning purposes such as measuring PRS from reliable positioning nodes, calculating position using PRS measurements based on PRS transmitted by reliable positioning nodes, reporting measurements based on reliable positioning nodes, and/or calculating a position based on PRS measurements.

According to implementations, one or more of the following criteria can be used to determine a priority for positioning prioritization purposes:
PRS transmitter mobility: For instance, out of a plurality of PRS transmitters, PRS transmitters that are most stationary (e.g., the least mobile) can be prioritized for evaluation.
   For instance, a lower mobility (e.g., lower velocity) is associated with a higher priority, and a higher mobility (e.g., higher velocity) is associated with a lower priority.
Estimated path loss between a PRS transmitter and a UE: For instance, PRS transmitters that have a smallest estimated path loss (e.g. based on signal to interference plus noise ratio (SINR)) are prioritized.
   For instance, a lower path loss is associated with a higher priority, and a higher path loss is associated with a lower priority.
Line of site (LOS) indication: For instance, whether a channel from an anchor-to-target UE is LOS or non-LOS (NLOS). For example, PRS measurements from LOS channels are prioritized.
   For instance, a LOS channel is associated with a higher priority, and a NLOS channel is associated with a lower priority.
Signal metrics: For instance, based on SL PRS measurement metrics such as RSRP, received signal strength indicator (RSSI), and/or other receives signal quality metric.
   For instance, a lower signal metric (e.g., RSRP, RSSI) is associated with a higher priority, and a higher signal metric is associated with a lower priority.
Based on a time-to-live indication: For instance, for how long (and/or until when) position reliability information can be considered to be valid. Alternatively or additionally position reliability information includes an expiry indication, e.g., after how much time (and/or after what time value) corresponding position reliability information is to be considered to be invalid.
   For instance, position reliability information considered to be valid is associated with a higher priority, and position reliability information considered to be invalid is associated with a lower priority. Additionally or alternatively, position reliability information considered to be valid for a longer remaining time can be associated with a higher priority than position reliability information considered to be valid for a shorter remaining time.

According to implementations, a target UE is configured with the one or more priority criteria, e.g., which priority criteria to apply for determining position reliability information. Based on the determined priorities, the target UE can select a subset of PRS transmitters and/or measurements derived from PRS reception from a subset of PRS transmitters. For example, if the target UE categorizes the PRS transmitters in low-priority and high-priority PRS transmitters, it may evaluate only the PRS received from the high-priority PRS transmitters. Alternatively or additionally, the UE may only report measurements based on PRS reception from high-priority transmitters.

According to one or more implementations, a target UE is configured with a number of PRS transmitters to be selected. According to another implementation, the target UE establishes a ranking of PRS transmitters based on correspondence to priority criteria. For example, PRS transmitters can be ranked based on a path loss, PRS transmitter velocity, RSRP, RSSI etc., and N PRS transmitters that exhibit the highest priority can be selected. For example if there are T PRS transmitters available and they are prioritized according to their velocity, the target UE can select N≤T PRS transmitters with the lowest velocity. In at least one implementation, a target UE is configured with the number N.

According to one or more implementations, a target UE updates a determined priority when detecting updated information about a PRS transmitter's priority criteria. For example if the estimated path loss from a PRS transmitter changes by more than a threshold from a previous value, the corresponding priority for the PRS transmitter can be re-evaluated. In another example, if a target UE receives information that a PRS transmitter that was previously mobile has become stationary, the corresponding priority can be re-evaluated.

According to one or more implementations, a target UE reports only measurements from selected PRS transmitters (e.g., to an LMF and/or other calculating unit (e.g. RSU)) such as to conserve reporting overhead. A configuration entity (e.g., LMF) can configure how many reports to include and/or criteria for selection (e.g., may be positioning algorithm specific), such as one or more of the priority criteria described above. Further, a UE may determine a number of reports to be included and header information pertaining to the information can indicate the number of reports.

According to one or more implementations, a target UE requests PRS transmission from selected PRS transmitters only. The request can be sent to an LMF and/or one or more selected PRS transmitters for example by means of a PRS request and/or a PRS trigger in a control message such as sidelink control information (SCI).

According to one or more implementations, a subset of PRS transmitters can be selected in accordance with a positioning accuracy parameter (e.g., accuracy requirement) for a positioning service. For example for positioning an IIoT device, a very high location accuracy (e.g. less than 0.5 metres) may be indicated, so that only PRS transmitters with a very high reliability (e.g., very high priority) can be selected. In another example positioning a road vehicle may have not as tight accuracy requirements (e.g., less than 1.5 metres) so that PRS transmitters with a high reliability (e.g., high priority) or higher can be selected.

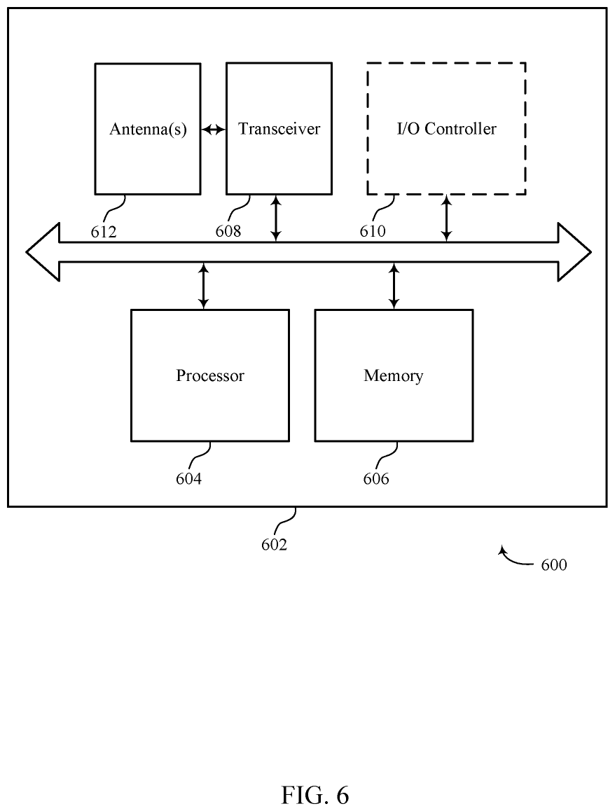

FIG. 6 illustrates an example of a block diagram 600 of a device 602 (e.g., an apparatus) that supports position reliability information for device position in accordance with aspects of the present disclosure. The device 602 may be an example of UE 104 as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606). In the context of UE 104, for example, the transceiver 608 and the processor coupled 604 coupled to the transceiver 608 are configured to cause the UE 104 to perform the various described operations and/or combinations thereof.

For example, the processor 604 and/or the transceiver 608 may support wireless communication at the device 602 in accordance with examples as disclosed herein. For instance, the processor 604 may be configured as and/or otherwise support a means to generate position reliability information, wherein the position reliability information includes an estimated indication of a trust status of the position for a device; and transmit position reliability information.

Further, in some implementations, the position reliability information is one or more of determined by or includes at least one of a velocity, an accuracy, a velocity class, or an accuracy class; the apparatus includes the device for which the position reliability information is generated; the processor is configured to transmit the position reliability information and a positioning reference signal; the position reliability information includes a message from a location management function (LMF) entity; the apparatus includes a device other than a device for which the position reliability information is generated; the position reliability information includes an indication of a mobility of the device; the position reliability information includes an indication of the position reliability for a plurality of spatial dimensions; the position reliability information includes an indication of a time to live for the position reliability information; the position reliability information includes an indication of a reliability value of the position reliability information relative to a defined threshold reliability.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The processor 604 of the device 602, such as a UE 104, may support wireless communication in accordance with examples as disclosed herein. The processor 604 includes at least one controller coupled with at least one memory, and is configured to or operable to cause the processor to perform various operations described herein such as with reference to the UE 104.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor M08. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (e.g., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

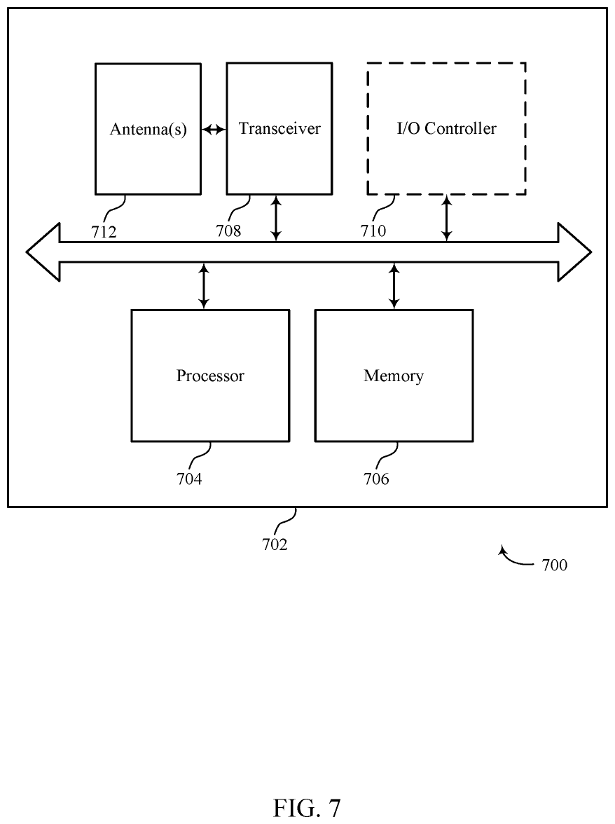

FIG. 7 illustrates an example of a block diagram 700 of a device 702 (e.g., an apparatus) that supports position reliability information for device position in accordance with aspects of the present disclosure. The device 702 may be an example of a network entity 102 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706). In the context of network entity 102, for example, the transceiver 708 and the processor 704 coupled to the transceiver 708 are configured to cause the network entity 102 to perform the various described operations and/or combinations thereof.

For example, the processor 704 and/or the transceiver 708 may support wireless communication at the device 702 in accordance with examples as disclosed herein. For instance, the processor 704 may be configured as or otherwise support a means to receive position reliability information, wherein the position reliability information includes an estimated indication of a trust status of the position for a first device; and estimate a position of a second device based at least in part on the position reliability information for the first device.

Further, in some implementations, the position reliability information includes one or more of a velocity, an accuracy, a velocity class, or an accuracy class; the apparatus includes the second device for which the position is estimated; the processor is configured to transmit the position reliability information and a positioning reference signal; the position reliability information includes a message from a location management function (LMF) entity; the apparatus includes a device other than a device for which the position reliability information is generated; the position reliability information includes an indication of a mobility of the device; the position reliability information includes an indication of the position reliability for a plurality of spatial dimensions; the position reliability information includes an indication of a time to live for the position reliability information; the position reliability information includes an indication of a reliability value of the position reliability information relative to a defined threshold reliability.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor M06. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (e.g., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

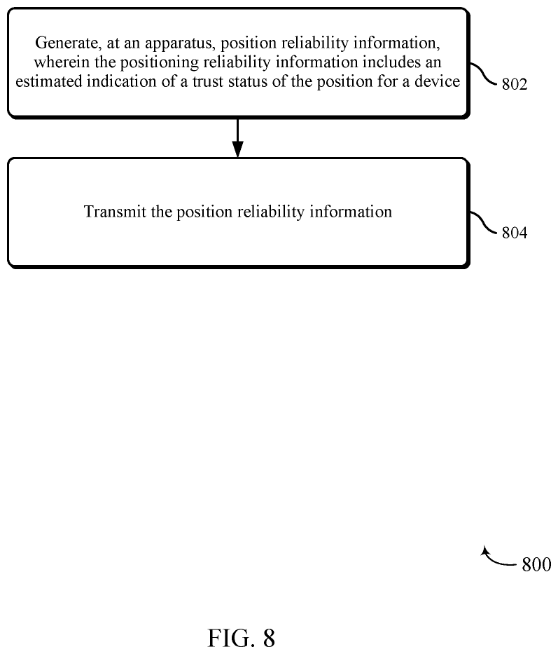

FIG. 8 illustrates a flowchart of a method 800 that supports position reliability information for device position in accordance with aspects of the present disclosure. The operations of the method 800 may be implemented by a device or its components as described herein. For example, the operations of the method 800 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include generating, at an apparatus, position reliability information, wherein the position reliability information includes an estimated indication of a trust status of the position for a device. The operations of 802 may be performed in accordance with examples as described herein. In some implementations, aspects of the operations of 802 may be performed by a device as described with reference to FIG. 1.

At 804, the method may include transmitting the position reliability information. The operations of 804 may be performed in accordance with examples as described herein. In some implementations, aspects of the operations of 804 may be performed by a device as described with reference to FIG. 1.

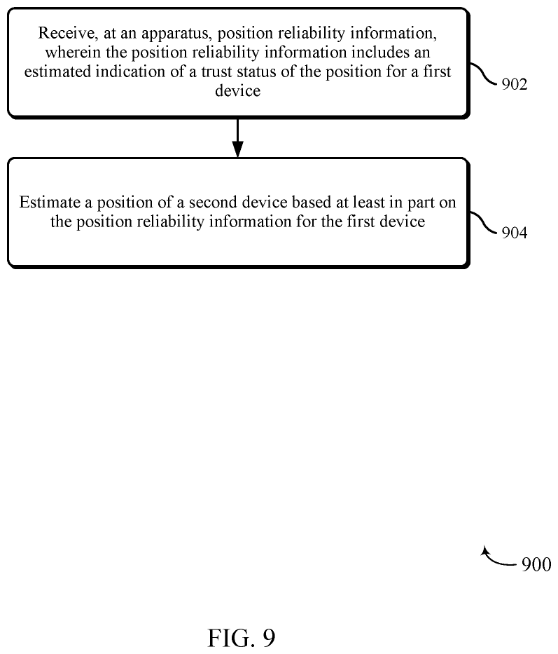

FIG. 9 illustrates a flowchart of a method 900 that supports position reliability information for device position in accordance with aspects of the present disclosure. The operations of the method 900 may be implemented by a device or its components as described herein. For example, the operations of the method 900 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include receiving, at an apparatus, position reliability information, wherein the position reliability information includes an estimated indication of a trust status of the position for a first device. The operations of 902 may be performed in accordance with examples as described herein. In some implementations, aspects of the operations of 902 may be performed by a device as described with reference to FIG. 1.

At 904, the method may include estimating a position of a second device based at least in part on the position reliability information for the first device. The operations of 904 may be performed in accordance with examples as described herein. In some implementations, aspects of the operations of 904 may be performed by a device as described with reference to FIG. 1.

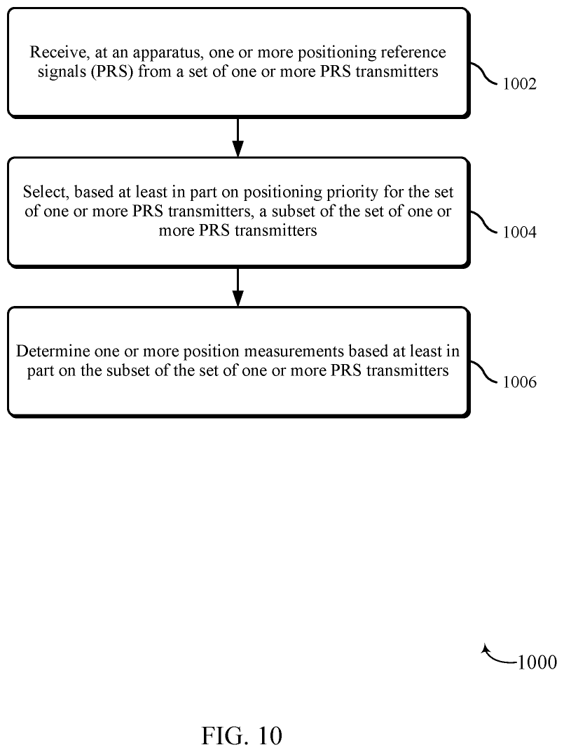

FIG. 10 illustrates a flowchart of a method 1000 that supports position reliability information for device position in accordance with aspects of the present disclosure. The operations of the method 1000 may be implemented by a device or its components as described herein. For example, the operations of the method 1000 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1002, the method may include receiving, at an apparatus, one or more positioning reference signals (PRS) from a set of one or more PRS transmitters. The operations of 1002 may be performed in accordance with examples as described herein. In some implementations, aspects of the operations of 1002 may be performed by a device as described with reference to FIG. 1.

At 1004, the method may include selecting, based at least in part on positioning priority for the set of one or more PRS transmitters, a subset of the set of one or more PRS transmitters. The operations of 1004 may be performed in accordance with examples as described herein. In some implementations, aspects of the operations of 1004 may be performed by a device as described with reference to FIG. 1.

At 1006, the method may include determining one or more position measurements based at least in part on the subset of the set of one or more PRS transmitters. The operations of 1006 may be performed in accordance with examples as described herein. In some implementations, aspects of the operations of 1006 may be performed by a device as described with reference to FIG. 1.

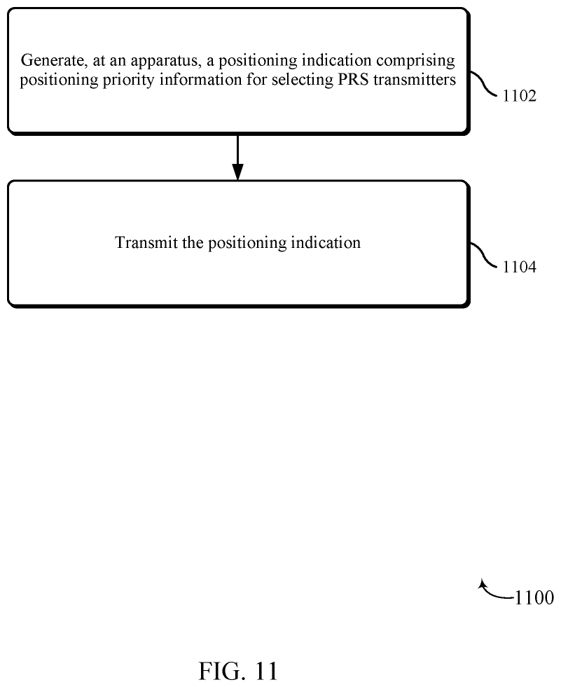

FIG. 11 illustrates a flowchart of a method 1100 that supports position reliability information for device position in accordance with aspects of the present disclosure. The operations of the method 1100 may be implemented by a device or its components as described herein. For example, the operations of the method 1100 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1102, the method may include generating, at an apparatus, a positioning indication comprising positioning priority information for selecting PRS transmitters. The operations of 1102 may be performed in accordance with examples as described herein. In some implementations, aspects of the operations of 1102 may be performed by a device as described with reference to FIG. 1.

At 1104, the method may include transmitting the positioning indication. The operations of 1104 may be performed in accordance with examples as described herein. In some implementations, aspects of the operations of 1104 may be performed by a device as described with reference to FIG. 1.

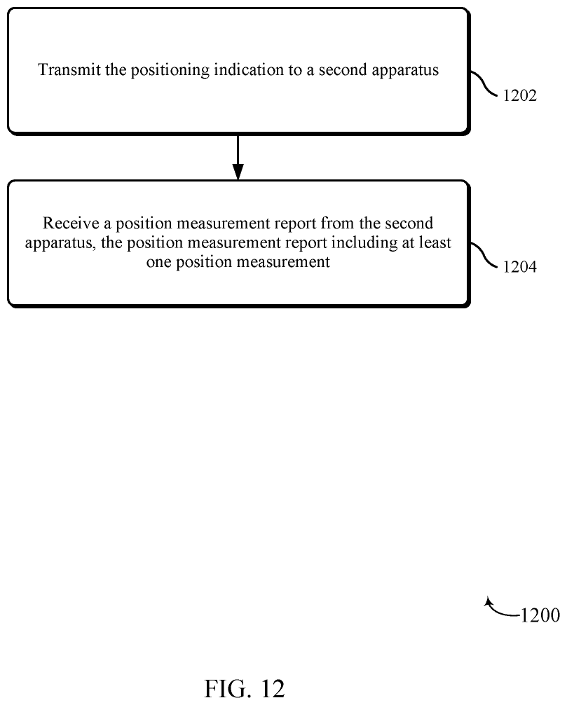

FIG. 12 illustrates a flowchart of a method 1200 that supports position reliability information for device position in accordance with aspects of the present disclosure. The operations of the method 1200 may be implemented by a device or its components as described herein. For example, the operations of the method 1200 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1202, the method may include transmitting the positioning indication to a second apparatus. The operations of 1202 may be performed in accordance with examples as described herein. In some implementations, aspects of the operations of 1202 may be performed by a device as described with reference to FIG. 1.

At 1204, the method may include receiving a position measurement report from the second apparatus, the position measurement report including at least one position measurement. The operations of 1204 may be performed in accordance with examples as described herein. In some implementations, aspects of the operations of 1204 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1-20. (canceled)

21. A user equipment (UE) for wireless communication comprising:
at least one memory; and
at least one processor coupled with the at least one memory and configured to cause the UE to:
determine information for positioning of a device; and
transmit the information.

22. The UE of claim 21, wherein the information comprises a velocity associated with the device.

23. The UE of claim 22, wherein the velocity comprises a horizontal velocity, a vertical velocity, or a combination thereof.

24. The UE of claim 21, wherein the information comprises an accuracy associated with the positioning of the device.

25. The UE of claim 21, wherein the at least one processor is configured to cause the UE to:
transmit or receive a positioning reference signal (PRS),
wherein the information associated with the positioning of the device is determined based at least in part on the transmitted or received PRS.

26. The UE of claim 21, wherein the at least one processor is configured to cause the UE to receive the information from a location management function (LMF).

27. The UE of claim 21, wherein the information indicates a mobility of the device.

28. The UE of claim 21, wherein the information indicates a position reliability for a plurality of spatial dimensions.

29. A method performed by a user equipment (UE) for wireless communication, the method comprising:
determining information for positioning of a device; and
transmitting the information.

30. The method of claim 29, wherein the information comprises a velocity associated with the device.

31. The method of claim 30, wherein the velocity comprises a horizontal velocity, a vertical velocity, or a combination thereof.

32. The method of claim 29, wherein the information comprises an accuracy associated with the positioning of the device.

33. The method of claim 29, further comprising transmitting or receiving a positioning reference signal (PRS), wherein the information associated with the positioning of the device is determined based at least in part on the transmitted or received PRS.

34. The method of claim 29, further comprising receiving the information from a location management function (LMF).

35. The method of claim 29, wherein the information indicates a mobility of the device.

36. The method of claim 29, wherein the information indicates a position reliability for a plurality of spatial dimensions.

37. A base station for wireless communication, comprising:
at least one memory; and
at least one processor coupled with the at least one memory and configured to cause the base station to:
receive information associated with a position of a first device; and
estimate a second position of a second device based at least in part on the received information associated with the position of the first device.

38. A method performed by a base station for wireless communication, the method comprising:
receiving information associated with a position of a first device; and
estimating a second position of a second device based at least in part on the received information.

39. The method of claim 38, wherein the information comprises a velocity associated with the first device.

40. The method of claim 39, wherein the velocity comprises a horizontal velocity, a vertical velocity, or a combination thereof.
